(19) United States
(12) Patent Application Publication
(10) Pub. No.: US 2010/0047015 A1
(43) Pub. Date: Feb. 25, 2010

(54) COMPOSITION AND PROCESS OF USING AN ASPHALT EMULSION TO CONVERT AN UNPAVED SURFACE INTO A PAVED SURFACE

(75) Inventors: Koichi Takamura, Charlotte, NC (US); Armin Burghart, Charlotte, NC (US); William Kirk, Rock Hill, SC (US)

Correspondence Address: FISH & RICHARDSON P.C., P.O BOX 1022, Minneapolis, MN, 55440-1022, US

(73) Assignee: BASF SE, Rheinland-Pfalz (DE)

(21) Appl. No.: 12/196,096

(22) Filed: Aug. 21, 2008

(51) Int. Cl. E01C 3/00; B05D 5/10; C09D 195/00

(52) U.S. Cl. 404/31; 427/138; 106/277

(57) ABSTRACT

The invention is a cost-effective method and formulation for cold paving applications that can be used to convert an unpaved surface, such as a gravel or dirt roadway, into a paved surface. The method includes applying an asphalt emulsion comprising asphalt, water, one or more emulsifiers, and a polymer to an existing unpaved surface to provide a layer of asphalt emulsion. An aggregate is then deposited over the emulsion layer to form a paved surface. The asphalt emulsion is formulated so that it can be used in a wide variety of conditions and with locally available aggregate. The set rate and viscosity of the asphalt emulsion can be selected so that it is able to penetrate partially into the unpaved surface to further improve the stability and rain resistance of the roadway.

### FIELD OF THE INVENTION

The invention relates generally to the paving of road systems, and more particularly to a method and composition for paving an existing unpaved road.

### BACKGROUND OF THE INVENTION

For many developing countries, extensive portions of the road system may comprise no more than a graded surface made of natural earth, gravel, stone, or similar materials. Such unpaved road systems may provide significant disadvantages. In particular, unpaved roads may not possess the strength that is necessary for supporting vehicular traffic. In many cases, the unpaved roads may be constructed from native soils that are found in close proximity to the road site. Such native soils may lack adequate soil strength. Inadequate soil strength can lead to defects in the road surface, such as rutting, corrugation, cracking and gross shifts in the load surface. Additionally, the strength of unpaved roads may fluctuate during the course of the year due to the changes in climatic conditions, which may result in compromising the stability and load-bearing capacity of the road. For example, adverse climate and loading conditions, such as freeze-thaw variations and alternating dry-out shrinkage and wetting/swelling, can result in the formation of waves, transverse corrugations, rutting, and shoving. Such changes in unpaved roads may make them unsuitable for use.

In many countries, the lack of a well-developed road and highway system continues to present a major obstacle to economic development. For example, studies have established that a significant relationship between a country's economical well-being and its road infrastructure. See for example, Queiroz et al. National Economic Development and Prosperity Related to Paved Road Infrastructure, TRANSPORTATION RESEARCH RECORD 1455, 147-152 (1994). A well-developed and well-maintained highway system can provide improvements in access to goods and services, education, and employment opportunities. To further develop rural areas, it may be desirable to provide a smooth and dust free surface with adequate strength and skid resistance for light traffic under dry conditions that can still maintain adequate strength during a rainy day or season. Paving may provide one possible solution to developing rural road systems. However, paving in a rural setting presents several challenges, such as lack of available supplies; lack of the necessary machinery and the skilled labor necessary to operate the machinery; and the proximity of processing facilities to the job site. As a result, the cost of paving rural road systems can be prohibitively expensive. This can be especially true in developing countries where financial resources may be limited.

Three common methods of paving include concrete paving, hot asphalt paving, and cold asphalt paving. Paving with concrete may be undesirable because of the high cost of materials, requirement of skilled labor, and the necessity of sophisticated paving machines. In many cases, the concrete mix has to be transported from a processing facility to the job site within 1 to 1.5 hours to prevent premature setting of the concrete mix. Such requirements are typically not practical for concrete paving in rural areas.

Asphalt paving with hot asphalt also suffers from similar disadvantages. In particular, hot asphalt mixing generally requires sophisticated plant technology where the molten asphalt is mixed with sorted aggregate which is heated to near 200° C. In many applications it also requires crushed aggregate of appropriate grading, engineered sand, and anti-stripping additives. The combination of the hot asphalt and aggregate should be delivered to the paving site with in about 1 hour to prevent premature cooling and setting. Once at the paving site, a series of paving machines, such as spreaders and compactors, are used to construct an asphalt surface. In addition to sophisticated machinery, the use of hot asphalt also requires well-trained laborers to operate the machinery. As a result, hot asphalt mixing is also not practical in many rural settings.

The third common paving technique is cold paving. Cold paving uses an asphalt emulsion that can be stored for prolonged periods of time without particular care. As a result, asphalt emulsions used in cold paving can be transported over relatively longer distances in a tank car or storage container. However, many cold paving techniques utilize special grades of aggregate that have to be crushed and cleaned so as to provide adequate adhesion between the asphalt and the aggregate. Providing such aggregate typically requires specialized machinery and source material. In many cases, such source material may not be readily available or may be prohibitively expensive to obtain. As a result, the use of conventional cold paving techniques may also not be practical in rural settings.

Thus, there exists a need for an asphalt formulation and method that can be used to efficiently provide paved roadways in rural settings.

### BRIEF SUMMARY OF THE INVENTION

The present invention provides a cost-effective method and formulation for cold paving applications that can be used to convert an unpaved surface, such as dirt, gravel, soil, clay or sand, into a paved surface. In one embodiment, the method includes applying an asphalt (bitumen) emulsion comprising asphalt, an emulsifier, a polymer, and water to an existing unpaved surface to provide a layer of the asphalt emulsion. In a subsequent step, an aggregate is deposited over the emulsion layer to form a paved surface. The asphalt emulsion is formulated so that it can be used in a wide variety of conditions and with a wide variety of aggregates. The flexibility of the asphalt emulsion permits it to be used with aggregate that is locally available. As a result, the costs associated with specialized aggregate, such as manufacturing, shipping, etc., can be reduced or eliminated. Additionally, the asphalt emulsion and the aggregate can be deposited using machinery that is used in conventional chip seal techniques. As a consequence, the need for specialized machinery and skilled labor can be reduced or eliminated, which can result in further cost savings.

Prior to setting of the asphalt emulsion, the aggregate material is deposited over the previously applied asphalt emulsion to form an outer use layer that is a mixture of aggregate and the asphalt emulsion. Thereafter, the asphalt emulsion is permitted to set. During setting, an asphalt-polymer matrix is formed that binds the aggregate and the particles of the previously unpaved base material together to form a paved surface. The resulting composite paved roadway is a combination of the asphalt-bound aggregate and the asphalt-bound base material of the previously unpaved roadway. A paved surface constructed according to the invention can be designed to set up at a faster rate in comparison to other conventional processes. As a result, traffic can be allowed on the paved road sooner than otherwise would be possible. In some embodiments, the paved road has developed sufficient strength to permit traffic within about an hour or less. The asphalt emulsion can be formulated to set within 15 to 30 minutes of applying the aggregate.

In some embodiments, the set rate and viscosity of the asphalt emulsion are selected so that the asphalt emulsion is able to penetrate at least partially into the unpaved surface to a desired depth. As explained in greater detail below, the desired depth to which the asphalt emulsion penetrates is typically dependent on several factors including the composition of the unpaved roadway, the expected use and level of traffic on the roadway, and the climatic conditions to which the roadway is exposed. In some embodiments, the asphalt emulsion is able to penetrate at least 0.5 inches into the unpaved surface, with a penetration between 1 and 8 inches being somewhat more preferred. During setting, which is also referred to as breaking, the asphalt and polymer components in the emulsion coalesce to form an asphalt-polymer matrix that is interdispersed amongst the materials of the base material (e.g., gravel, dirt, clay, soil or sand) and serves to bind these materials together. As a result, the asphalt-polymer matrix provides both stabilization and waterproofing of the base material.

As noted above, the asphalt emulsion comprises asphalt, an emulsifier, a polymer, and water. In one embodiment, the asphalt emulsion comprises an emulsion (e.g. a cationic emulsion) having a Brookfield viscosity between 5 and 500 mPa·s at 25° C., and preferably between 5 and 50 mPa·s at 25° C. The asphalt emulsion can be selected from the group consisting of rapid-setting emulsions, medium-setting emulsions, quick-setting emulsions, slow-setting emulsions, and combinations thereof.

Suitable polymers can include styrene-butadiene rubber latexes, natural rubber latexes, polychloroprene latexes, poly(styrene-butadiene-styrene block) copolymers, electrically neutral or cationic acrylic latexes, ethylene-vinyl acetate copolymers, and combinations thereof. In some embodiments, a concentrated asphalt emulsion can be prepared having between about 50 and about 80 weight percent asphalt based on the weight of the concentrated asphalt emulsion. In the concentrated asphalt emulsion, the amount of polymer is between 1 and 15 weight percent, between 2 and 8 weight percent, or between 3 and 5 percent, based on the weight of the asphalt in the emulsion. The amount of emulsifier in the emulsion is generally between 0.3 and 5 weight percent, based on the weight percent of the asphalt in the emulsion. The concentrated asphalt emulsion can be applied to a base layer to produce the paved surface or first diluted (e.g. with water) before it is applied.

In some embodiments, a first aggregate is deposited onto the emulsion layer in an amount that is selected to produce void spaces between the individual aggregate particles. A second and smaller aggregate is then applied over the first aggregate. The second aggregate has an average size that is smaller than the first aggregate and is able to fill the void spaces between the first aggregate. For example, a first aggregate, such as course aggregate, having an average size that is between ¼ to ¾ inches can be deposited onto the emulsion layer. In some embodiments, the amount of first aggregate deposited is selected to produce a layer of aggregate having void spaces. The first aggregate can comprise from about 35 to about 70% of the total amount of aggregate. A second aggregate, such as fine aggregate, having an average size that is smaller than the first aggregate is deposited to fill in the void spaces between the first aggregate. The first and second aggregates form an outer layer of the paved surface that is a combination of the first and second aggregate and the asphalt emulsion. Preferably, the second aggregate has an average size that is between 0.003 and 0.25 inches (e.g. between 0.003 and 0.1 inches). The amount of second aggregate is generally between 30 and 65%, based on the total amount of the aggregate.

In some embodiments, a fine aggregate is deposited over the emulsion layer without the deposition of a coarse aggregate. In this embodiment, the fine aggregate typically has an average size that is between 0.003 and 0.25 inches. In a more preferred embodiment, the aggregate has an average size between about 0.003 to 0.1 inches.

In some embodiments, the aggregate comprises a mixture of aggregate particles having a size distribution wherein about 0.1 to 5% of the aggregate by weight has a size that is less than about 0.1 inches, about 20 to 65% of the aggregate by weight has a size that is between 0.1 and 0.25 inches; and about 30 to 75% of the aggregate by weight has a size that is about 0.25 inches or greater.

From the foregoing discussion, it should be apparent that the present invention provides a cost-effective formulation and method that can be used to convert an existing unpaved surface such as an unpaved roadway into a paved roadway.

### BRIEF DESCRIPTION OF THE SEVERAL VIEWS OF THE DRAWING(S)

Having thus described the invention in general terms, reference will now be made to the accompanying drawing, which is not necessarily drawn to scale, and wherein:

FIG. 1 is a cross-sectional side view of a paved surface that is prepared in accordance with one aspect of the invention.

### DETAILED DESCRIPTION OF THE INVENTION

The present invention now will be described more fully hereinafter with reference to the accompanying drawing, in which one, but not all embodiments of the invention are shown. Indeed, this invention may be embodied in many different forms and should not be construed as limited to the embodiments set forth herein; rather, these embodiments are provided so that this disclosure will satisfy applicable legal requirements. Although specific terms are employed herein, they are used in a generic and descriptive sense only and not for purposes of limitation. The term “comprising” and variations thereof as used herein are used synonymously with the term “including” and variations thereof and are open, non-limiting terms. Like numbers refer to like elements throughout.

The invention is directed to a method and formulation for cold paving applications that can be used to convert an unpaved surface into a paved surface. The method includes applying an asphalt (bitumen) emulsion comprising asphalt, water, one or more emulsifiers, and a polymer to an existing unpaved surface to provide a layer of asphalt emulsion. An aggregate is then deposited over the emulsion layer to form a paved surface. The asphalt emulsion is formulated so that it can be used in a wide variety of conditions and with locally available aggregate. In some embodiments, the set rate and viscosity of the asphalt emulsion is selected so that it is able to penetrate partially into the unpaved surface to further improve the stability and rain resistance of the roadway. In other embodiments, the asphalt emulsion adheres to the unpaved surface with little to no penetration. The invention provides a simplified and cost-effective method of converting an existing unpaved roadway into a paved road.

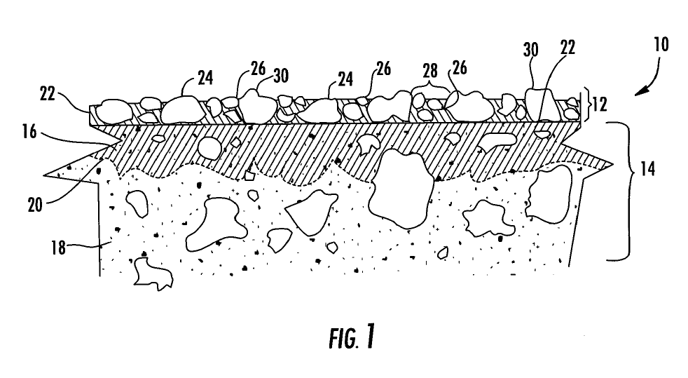

With reference to FIG. 1, a cross-sectional side view of a paved surface that is in accordance with one aspect of the invention is illustrated and broadly designated by reference number 10. The paved roadway 10 includes an outer use layer 12 and a base layer 14. The base layer 14 comprises a previously unpaved surface that is typically composed of gravel, dirt, soils, clays, sands or combinations thereof. It is the base layer 14 that provides support for the upper use layer 12. In the context of the invention, the term “gravel” refers to particles of varying sizes and dimensions that can include stones and rubble, whereas dirt, soils, clays and sands include generally smaller particles than gravel.

In some embodiments, the base layer 14 includes an upper portion 16 and a lower portion 18, which in FIG. 1 are depicted as being divided by the dashed line 20. Here, the dashed line 20 represents the depth of penetration of the asphalt emulsion into the base layer 14. The upper portion 16 comprises the region of the base layer in which the asphalt-polymer matrix 22 is interdispersed between individual particles of the base layer and binds the particles together, and the lower portion defines a region of the base layer that is substantially free of the asphalt-polymer matrix.

The outer use layer 12 comprises a mixture of aggregate of varying sizes. The aggregate preferably comprises a mix of aggregate particles of varying sizes so that smaller aggregate particles can effectively fill in voids between larger aggregate particles. In the illustrated embodiment, the outer use layer 12 includes a first aggregate 24 and a second aggregate 26. The first aggregate is deposited so that void spaces 28 exist between the individual aggregate particles 26. The second aggregate 26 is preferably deposited after the first aggregate and fills the void spaces 28. The first and second aggregates 24 and 26 are bound together with the asphalt-polymer matrix 22. The resulting paved surface provides improved durability and strength. In some embodiments, a portion 30 of the first aggregate can extend above the asphalt-polymer matrix to help enhance the skid resistance properties of the paved surface.

In some embodiments, a concentrated asphalt emulsion can be prepared. The asphalt (bitumen) content can be between about 30 and 80, between about 50 and 80, between about 50 and 75, or between about 55 and 70 weight percent based on the weight of the concentrated asphalt emulsion. The bitumen preferably has a mean particle diameter of about 1 to about 10 microns, more preferably, about 2 to about 3 microns. The amount of polymer is between about 1 and 15, between about 2 and 8, or between about 3 and 5 weight percent, based on the weight of the asphalt in the emulsion (i.e., between 1 and 6 percent and preferably between 1.5 and 3.8 percent based on the weight of the asphalt emulsion). The amount of emulsifier in the emulsion is generally between 0.3 and 5 weight percent, based on the weight percent of the asphalt in the emulsion. (i.e., between 0.15 and 3.8 percent based on the weight of the asphalt emulsion).

In some embodiments, the concentrated asphalt emulsion can be applied to a base layer to produce the paved surface, particularly when higher viscosity formulations are desired, e.g., when paving a sandy soil surface. In some embodiments, however, it may be advantageous to dilute the concentrated emulsion with water to an asphalt content of between about 25 and 50% by weight to provide lower viscosities, e.g., when paving a clay surface. In both the concentrated and diluted asphalt emulsions, the weight ratio of the asphalt to the polymer is typically from 12.5:1 to 50:1, and more preferably from 20:1 to 33:1. The weight ratio of the asphalt to the emulsifier is typically from 20:1 to 333:1. For example, a diluted asphalt emulsion can include between about 25 and about 50 weight percent asphalt, between about 0.5 and about 4 percent weight percent polymer, between about 0.08 and about 2.5 percent weight percent emulsifier, based on the weight of the diluted asphalt emulsion, and the balance including water and any acids for adjusting the pH (e.g. HCl).

The asphalt emulsions can be formulated so that the viscosity and set rate permit the asphalt emulsion to penetrate quickly and deeply into the unpaved surface. In one embodiment, the asphalt emulsion has a Brookfield viscosity of less than about 500 mPa·s at 25° C. Preferably, the asphalt emulsion has a Brookfield viscosity from about 5 to about 250 mPa·s at 25° C., and more preferably from about 5 to about 50 mPa·s at 25° C. In some embodiments, the asphalt emulsion may have a Brookfield viscosity that is less than about 35 mPa·s (e.g. about 5 to about 35 mPa·s), for example, between 5 and 20 mPa·s, particularly for use with less porous base layers such as clay. For some base layers, such as sand or sandy soil, that are highly porous, higher Brookfield viscosities can be preferred, e.g., greater than 50 mPa·s at 25° C. In some embodiments, the emulsion is formulated to have a setting time of less than about 60 minutes, and more preferably less than about 30 minutes.

As briefly discussed above, the process preferably includes applying an asphalt emulsion that penetrates quickly and deeply into the base material. Although the exact depth to which the asphalt emulsion penetrates will typically depend on the composition of the base material, it is generally desirable that the asphalt emulsion penetrates to a depth of at least 0.5 inches. In some embodiments, the asphalt emulsion can penetrate to a depth greater than about 1, 2, 3, 4, 5, 6, and 8 inches. In applications where the base material is comprised of about 50% sand or greater (e.g., particles passing a 0.2-inch sieve (No. 4) and retained on a 0.003-inch (No. 200) sieve), it is generally desirable for the asphalt emulsion to penetrate to a depth ranging from about 1 to 8 inches. In addition to penetrating the base material, the applied asphalt emulsion also provides a surface layer onto which the aggregate is deposited to form the outer use layer of the paved road. This surface layer of asphalt emulsion is generally from 0.01 to 0.075 inches thick. In some embodiments, the asphalt emulsion surface layer is about 0.05 inches thick. This surface layer becomes the outer use layer 12 upon setting of the asphalt emulsion.

The asphalt emulsion can be applied to the surface using a variety of techniques, such as spraying. In some embodiments, the asphalt emulsion is applied using a spraying technique that is similar to those used for applying fast setting asphalt emulsions (e.g. CRS) in conventional chip seal surface treatments. The asphalt emulsion can be sprayed using equipment that is used in conventional chip seal applications. Preferably, the asphalt emulsion is sprayed at an application rate that is about 2 to 3 times the spray rate that is used in conventional chip seal applications. The higher rate of spraying helps to improve penetration of the asphalt emulsion into the base material. Generally, the asphalt emulsion is sprayed at an application rate that is about 1.5 to 7.5 l/m². More preferably, the asphalt emulsion is sprayed at an application rate of about 3 to about 6 l/m².

In some cases the base material may be severely compacted, which may result in the asphalt emulsion failing to adequately penetrate the base material. In such cases, it may be desirable to break up a portion of the base material prior to applying the asphalt emulsion. In other cases, the base material can be modified to more readily absorb the asphalt emulsion. For example, a material having a relatively higher permeability, such as sand, can be blended with the compacted base material. As a result, the sand will more readily permit the penetration of the asphalt emulsion into the base material.

In one embodiment, the asphalt emulsion bonds to the base material with little or no penetration occurring. For example, the base material can comprise a compacted material that provides adequate support without the need for further stabilization. In such case, the asphalt emulsion can help provide water resistance to the base layer 14 and provide the surface layer onto which the aggregate is deposited.

After the asphalt emulsion is applied, aggregate is deposited onto the previously applied asphalt emulsion layer to form the outer use layer of the paved surface. Aggregate performs several useful functions including: 1) transmitting the load from the surface of the pavement down to the base material; 2) providing a wearing surface to withstand the abrasive action of traffic; and 3) providing a non-skid surface. In some embodiments, a portion of the aggregate can extend slightly above the normal surface to thereby provide a roughened surface that tires are able to grip. The aggregate can be “embedded” in the asphalt emulsion of the surface layer by rolling or other means.

In the present invention, the asphalt emulsion can be formulated to penetrate into the base material. As a result, the set rate of the asphalt is not as sensitive to the aggregate composition used, particularly compared to conventional chip seal treatment. This provides several advantages. First, a wide variety of different aggregate can be used in constructing the paved surface. This can be especially advantageous in rural settings where it may be desirable to use locally available materials as the source of the aggregate. Using locally available material can reduce or eliminate the need to use aggregate having a specific size or an aggregate wherein each particle has a uniform size. As a result, the need for sophisticated processing equipment to crush the aggregate source material can be eliminated. Additionally, the use of locally available materials also reduces the need to transport aggregate over long distances to reach the job site. Second, the need of washing the aggregate can also be reduced or eliminated. As a consequence of these advantages, the invention provides significant cost savings in comparison to current methods of constructing paved roads.

In one embodiment, the aggregate comprises a blend of particles having varying sizes and shapes. The aggregate typically comprises a mineral aggregate comprising crushed rock, crushed or uncrushed soils, including gravels and sands, slag, mineral filler, or combinations thereof. Depending upon the local geology, the aggregate can also include vesicular lava and coral. The aggregate can be selected from coarse, fine, and combinations thereof. Typically, the aggregate comprises a mixture of different sized particles that have sizes ranging from less than about 0.003 inches to about 0.5 inches or greater.

Coarse aggregate generally refers to material that is too large to pass through a No. 4 sieve (0.2 inches), as determined in accordance with ASTM D-692-88. Fine aggregate generally refers to material that passes through a No. 4 sieve (less than 0.2 inches), but is predominately retained on a No. 200 sieve (greater than 0.003 inches). Fine aggregate can be measured in accordance with ASTM D-1073-88.

Aggregate can also be classified according ISSA standards as Type I, II or III aggregate. The size of Type I and Type II aggregate are generally encompassed by the definition of fine aggregate. Type I aggregate is typically smaller than about 0.1 inches (No. 8 sieve), but is generally greater than about 0.003 inches (No. 200 sieve). In some embodiments, Type I aggregate can have an average aggregate size that is less than about 0.002 inches (approximately 45 microns). Type II is also roughly encompassed by the definition of fine aggregate and is coarser than a Type I aggregate. Type II aggregate typically has a maximum aggregate size of about 0.2 inches or less. Type III aggregate generally includes fine and coarse aggregate. Type III aggregate typically has an average aggregate size from about 0.05 to 0.10 inches, with a maximum aggregate size of about 0.5 inches.

In some embodiments, the aggregate comprises a first aggregate having an average particle size that is about 0.25 inches or greater, and a second aggregate having an average particle size that is less than the average particle size of the first aggregate. For example, in one embodiment, the first aggregate comprises a mixture of particles having an average size greater than about 0.25 inches, and the second aggregate comprises a mixture of fine aggregate particles having an average size that is less than about 0.25 inches, and more preferably less than 0.1 inches. In another embodiment, the aggregate comprises a blend of particles having the following size distribution: about 5% or less of the aggregate by weight is less than about 0.1 inches; about 20 to 65% of the aggregate by weight is between 0.1 and 0.25 inches, and about 30 to 75% of the aggregate by weight is greater than about 0.25 inches. In yet another embodiment, the aggregate has a size distribution wherein about 5% or less of the aggregate by weight is less than about 0.003 inches; about 20 to 30% of the aggregate by weight is between 0.003 and 0.1 inches, and about 65 to 75% of the aggregate by weight is greater than about 0.1 inches or greater.

In some embodiments, the outer use layer is formed by depositing a first layer of coarse aggregate having an average size that is from about ¼ to ¾ inches. Preferably, the first aggregate would be deposited on the asphalt emulsion layer at a low application rate, for example, about ⅓ to ½ the rate that is used in conventional chip seal applications. The typical application rate of aggregate is from 5 to 15 kg/M². As a result of this low application rate, small voids or gaps are created between the individual aggregate particles. The first aggregate forms an aggregate layer wherein up to about 70%, and preferably between 35 and 50%, of the area of the aggregate layer includes void spaces between the individual aggregate particles. In a next step, a second aggregate having a smaller particle size (e.g., Type I or Type II) is deposited over the first aggregate and fills these void spaces. The asphalt emulsion is then allowed to set to form the outer use layer 12 of the paved surface. Preferably, the particle size distribution of aggregate is selected to provide a densely or well-graded asphalt. In some embodiments, the aggregate can be deposited by using a chip seal spreader that has been modified to have two separate spreader boxes so that the two types of aggregate of differing sizes can be deposited one after the other in a single operation. In other embodiments, the various types of aggregate (e.g., the first and second aggregate) can be deposited simultaneously.

In some embodiments, a fine powder, such as mineral filler, can be combined with the aggregate to help increase the set rate of the asphalt emulsion. Fine powders can also be used to help reduce or prevent bleeding of the asphalt. The fine powder can be present in amounts from about 0.1 to 5 weight percent, and more typically in amounts from about 0.5 to 2 weight percent, based on the total weight of the aggregate. Fine powders that can be used in the practice of the invention include mineral filler, such as hydrated lime, limestone dust, Portland cement, silica, alum, fly ash, and combinations thereof. Mineral filler generally refers to a finely divided mineral product wherein at least 65 percent of which will pass through a No. 200 sieve, and typically has an average size that is less than 0.003 inches.

In some embodiments, the aggregate can be wetted with from about 4 to about 16 parts by weight water, more preferably, from about 8 to about 15 parts by weight water, per 100 parts aggregate, prior to being deposited onto the asphalt emulsion layer. The amount of water added is typically dependent on the fines content and their activity in the aggregate.

A second treatment of asphalt emulsion can be applied to the roadway before or after the aggregate has been deposited. The second asphalt emulsion layer can be used to provide additional strength and integrity to the paved road. Since penetration of the base material is no longer a concern, the second asphalt emulsion can have a relatively fast set rate, for example, on the order of 10 to 30 minutes. In this embodiment, a fast setting emulsion, such as CRS-1 or CRS-2 can be used for the second treatment.

As noted above, the asphalt emulsion comprises a blend of asphalt, water, emulsifier, and polymer. The formulation of the asphalt emulsion can vary depending upon the desired properties and the end use of the surface to be paved. In some circumstances the viscosity and setting rate of the asphalt emulsion can be selected based on the composition of the base material to be paved. For instance, if the base material consists of a conglomeration of relatively loose particles through which the asphalt emulsion can penetrate relatively easily, it may be desirable to use an emulsion having a higher viscosity and faster set rate. On the other hand, if the base material is composed primarily of compacted soils, such as clays, it may be desirable to use an asphalt emulsion having a relatively low viscosity and a slow set rate so that the asphalt emulsion can more easily penetrate into the surface.

Asphalt emulsions are generally classified on the basis of how quickly the emulsion will set. The terms RS, MS, QS, and SS have been adopted to simplify and standardize this classification. They are relative terms and mean rapid-setting, medium-setting, quick-setting, and slow-setting, respectively. The category for a given emulsion can be determined according to ASTM D-2397, the contents of which are hereby incorporated by reference. Typically, an RS emulsion has little to no ability to mix with an aggregate because it sets too quickly, an MS emulsion is typically mixed with coarse aggregate, and an SS emulsion can be mixed with a fine aggregate. The setting properties of QS emulsions are typically somewhere between MS and SS emulsions.

Asphalt emulsions are further subdivided by a series of numbers related to viscosity of the asphalt emulsion and hardness of the base asphalt cements. The letter “C” in front of the emulsion type denotes cationic. The absence of the “C” denotes anionic or nonionic. For example, RS-1 is anionic or nonionic and CRS is cationic.

Suitable asphalt emulsions for use in the invention include SS, CSS, CQS, QS, MS, and CMS emulsions, and combinations thereof. In some embodiments, the asphalt emulsion is cationic and is selected from the group consisting of CSS-1, CSS-1h, CMS-1, CMS-1h and CQS-1h, and combinations thereof. In addition, the asphalt emulsion can comprise a CRS-2 emulsion that is combined with a slower setting emulsion such as CQS to thereby modify the wetting and setting characteristics of the original asphalt emulsion to achieve a desired penetration into the base material. In other embodiments, a rapid-setting emulsion can be used and combined with additional emulsifiers to slow the set rate of the emulsion.

In some embodiments, the asphalt emulsion is a quick setting asphalt emulsion having a Brookfield viscosity that is between 5 and 35 mPa·s, and preferably between 5 and 20 mPa·s. A CQS emulsion can be particularly useful in the practice of the invention for several reasons. In many conventional paving and surfacing techniques, the asphalt emulsion has to be specially formulated for the type of aggregate being used and the local climate conditions. The method of the present invention is generally not limited by these constraints because the aggregate is deposited directly onto the asphalt emulsion, rather than being mixed with the asphalt emulsion. Additionally, the set rate is generally selected to permit penetration into the base material. As a result, the amount of fine aggregate is generally less than other techniques and premature breaking is not as significant a concern. This permits a single CQS asphalt emulsion to be used in a wide variety of paving conditions that may be encountered. The CQS can then be modified by dilution to have the desired rate of penetration. Additionally, the setting characteristics of the CQS emulsion can be modified by the inclusion of mineral filler, such as lime, in the aggregate.

In some embodiments, the set rate can be controllably adjusted by combining the asphalt emulsion with one or more additional components (e.g., emulsifiers) that permit the set rate of the emulsion to be changed. For example, if a faster set rate is desired, a CRS emulsion can be added to an asphalt emulsion having a relatively slower set rate to thereby increase the set rate. This can be particularly useful in applications where the base material comprises a relatively loose conglomerate of particles, such as sand. On the other hand, if the base material is a relatively more compact material, it may be desirable to slow the set rate so that the asphalt emulsion has sufficient time to penetrate the base material. Methods of slowing the set rate include adding slower setting emulsifiers and diluting the asphalt emulsion with water, for example. In one embodiment, the emulsion can comprise a CRS emulsion that is diluted to decrease its viscosity and set rate. For example, the viscosity and set rate of a CRS emulsion can be modified by dilution with about 30, 50, 65, and up to 70 percent water.

As noted above, the amount of fine powders in the aggregate can be adjusted to increase the set rate of the asphalt emulsion. Generally, greater amounts of fines in the aggregate result in faster setting rates for the asphalt emulsion. Selectively adjusting the amount of fines in the aggregate can have several advantages. For example, it can initially allow the asphalt emulsion to be formulated to have a set rate that permits that asphalt emulsion to penetrate into the base material. Thereafter, when the aggregate is deposited, the amount of fines in the aggregate can be selected to allow a more rapid breaking of the emulsion so that the resulting paved road can be set at a faster rate.

In some embodiments, the asphalt emulsion can be adjusted on the job site by selectively mixing one or more additional components with the asphalt emulsion. This can be accomplished by adding the additional component(s) directly to the storage tank from which the asphalt emulsion is being applied, or by mixing the additional component(s) with the asphalt emulsion as it is being applied to the base material.

The ability to selectively control the viscosity and set rate of the asphalt emulsion provides several advantages. For example, the composition of an unpaved roadway may vary along its length. As a result, an asphalt emulsion that provides a desired penetration along one portion of the roadway may not have adequate penetration on a later portion of the roadway. Adjusting the set rate and viscosity of the asphalt emulsion on-site helps to eliminate the need for supplying/preparing new formulations when changes in the composition of the base material are encountered. As a result, the paving process can help reduce costs and delays that may otherwise be associated with such changes in the base material. Additionally, it can help provide a stronger and more durable road surface because a formulation tailored to a specific composition can more readily be made available.

In some embodiments, the asphalt emulsion includes one or more cationic latex polymers. Accordingly, the asphalt emulsion preferably includes a cationic emulsifier. A wide variety of different cationic emulsifiers can be used in the practice of the invention including CRS, CSS, CQS, and CMS emulsifiers. Particularly preferred emulsifiers include emulsifiers that are generally used in CQS emulsions, such as Redicote® C-404, C-320, C-450, C-462, C-471, C-480, and Redicote® E9A all from Akzo Nobel; and Indulin W-1, W-5, MQK, MQK-1M, QTS, all from MeadWestvaco.

The asphalt emulsions used in the invention can have pH's in the range of 1.0 to 3.5. Thus, asphalt emulsions can be used with higher pH's than are typically used in slurry seal and microsurfacing applications, which typically have a pH of 1.0 to 1.5. These asphalt emulsions are made with asphalt having a high acid number and the lower pH is accomplished through the use of acids such as hydrochloric, phosphoric, sulfuric, and oxalic acids. Generally, asphalt emulsions having higher pH's have been known to either not develop enough cohesion or to have slow cohesion development resulting in increased curing time being needed before the newly paved surface can be opened to traffic. Nevertheless, higher pH emulsions can be used in the asphalt formulations of the invention.

The asphalt emulsion is typically prepared by first preparing a soap solution containing water and one or more surfactants, and then adjusting the pH of the soap solution using an acid such as HCl as mentioned above. The soap solution and preheated asphalt are then generally pumped into a colloid mill where high shear mixing produces the asphalt emulsion having asphalt droplets dispersed in the water.

Typically the asphalt emulsions are polymer-modified, e.g., to increase the strength and durability of the resulting asphalt-based, cold paving formulations and to decrease the curing times of these formulations. Typically, a polymer latex is added to the soap solution and the asphalt emulsion is produced as discussed above. Alternatively, the polymer latex can be added to the asphalt emulsion after it has been prepared or the polymer latex can be combined with the asphalt prior to mixing the asphalt with the soap solution to produce the asphalt emulsion.

Suitable polymer latexes for use in the formulations include cationic SBR (styrene-butadiene rubber) latexes, natural rubber latexes, and polychloroprene latexes (e.g. NEOPRENE® latexes available from E.I. Du Pont de Nemours). Electrically neutral or cationic acrylic latexes such as those described in pending U.S. patent application Ser. Nos. 11/399,816, 11/400,623 and 11/868,236, which are hereby incorporated by reference in their entirety. SBS (poly(styrene-butadiene-styrene)) block copolymers and EVA (ethylene-vinyl acetate) copolymers can also be used but typically must be added slowly to heated asphalt (e.g. 160-170° C.) and then subjected to high shear mixing to disperse the polymer in the asphalt prior to forming the asphalt emulsion. Preferably, a cationic SBR latex is used in the asphalt emulsion. The cationic SBR latex emulsion typically includes between about 0.1 and about 10%, and more preferably, between about 1.0% and about 4.0%, by weight cationic surfactants. The SBR latex emulsion is typically included in the asphalt emulsion in an amount from greater than 0 to about 10%, more preferably from 2.0 to 10%, and even more preferably from 2.0 to 5% by weight, based on the weight of polymer solids per weight of asphalt. Suitable cationic SBR latexes for use in the invention include BUTONAL® NX1118, NX1138 and NS 198, commercially available from BASF Corporation.

As should be apparent from the preceding description, the present invention can be used to provide an efficient and low cost method of converting an unpaved road into a paved surface. The flexibility of the invention permits the paving of a wide variety of base materials and also permits the use of locally available materials as aggregate.

The present invention can further be used to pave roads, parking lots, airstrips, nature trails, bicycle paths, and the like. Paving of these surfaces provide increased strength and resistance to erosion from travelers, while also protecting the route from wind and water erosion, potentially saving costly future repair. The paved surface can also be accessible to many types of vehicles, as well as persons with disabilities who may be traveling the landscape in an alternative means, such as, for example, a wheelchair, by providing a smooth and compact travel surface. Travelers on paved paths would further benefit from the reduction of dust particles and control of vegetative growth which creates a safer more passable route.

The following examples, are provided for illustrative purposes only and should not be construed as limiting the invention. Except where noted otherwise, the Brookfield viscosity is measured at 25° C. at 20 rpm and the Saybolt Furol viscosity (SFS) is measured at 50° C. using ASTM D2397.

### EXAMPLES

### Preparation of CQS Asphalt Emulsion

A latex modified CQS-2 polymer emulsion was prepared with Ergon® AC-20 asphalt, 3% by weight Butonal® NX1118 based on the total weight of the asphalt, and a soap solution containing equal amounts of Redicote® C-404 and Redicote® E9A (Akzo Nobel) at a total amount of 2.4% by weight based on the total weight of the asphalt. The pH of the soap solution was adjusted to about 1.0 with HCl. The asphalt emulsion had an asphalt content of 65% by weight, 2% by weight Butonal® NX1118, and 1.5% by weight total of the Redicote® C-404 and Redicote® E9A. The viscosity of the CQS-2 emulsion was 375 mPa·s at 25° C. (Brookfield viscosity at 20 rpm), which is approximately 180 seconds using the Saybolt Furol (SFS), and the pH=1.2. The resulting emulsion was diluted to 45% with water to have a Brookfield viscosity of 35 mPa·s (SFS<20 seconds). Further dilution to 30% resulted in a Brookfield viscosity of 5 mPa·s. The asphalt emulsion was stable and can be stored at room temperature.

### Preparation of CRS-2 Asphalt Emulsion

A latex modified CRS-2 emulsion was prepared with Ergon® AC-5 asphalt, 3% by weight Butonal® NX1118 based on the total weight of the asphalt, and a soap solution containing 0.45% by weight Redicote® E-4819 based on the total weight of the asphalt. The pH of the soap solution was adjusted to slightly below 2.0 with HCl. The asphalt emulsion prepared had an asphalt content of 71% by weight, 2.1% by weight Butonal® NX1118, and 0.30% by weight Redicote® E-4819. The emulsion had a Brookfield viscosity of 2950 mPa·s (SFS of 1400s) at 50° C. and a pH=2.1.

### Example 1

### Adherence of the Paved Surface to a Felt Base Material

Test method ASTM D7000-4 was used to test the adherence of the paved surface to an underlying base material. A stainless steel strike-off template of 280 mm in diameter was cut out and placed on an asphalt felt disc of 30 cm×36 cm (30 lb. asphalt felt paper, ASTM D226). 80 g of the 65% CQS asphalt emulsion was spread evenly within the opening of the strike-off plate. 250 g of unwashed coarse aggregate (100% passing through a 9.5 mm sieve and <1% passing through a #4 sieve) were immediately spread evenly on the wet asphalt emulsion. The amount of the aggregate spread on the felt roughly approximated about ½ of the typical application rate for a convention chip seal application. 250 g of finely graded Delta Type II aggregate (having a particle size distribution ranging from 0.003 to 0.25 inches) was mixed with 5 g of lime, and then applied to cover voids on the felt among chip seal aggregate. After removing the strike-off plate, the entire felt with the asphalt emulsion and aggregate was placed in a forced airflow oven controlled at 35° C. for 1.5 hours. No bleeding of the asphalt emulsion was observed and the majority of the aggregate except some excess Delta aggregate was firmly adhered on the felt when the sample was removed from the oven. Excess Delta aggregate was washed with water, which made larger size aggregate exposed for better skid-resistance. The entire felt, where the asphalt emulsion was applied, remained well covered with aggregate.

### Example 2

From the above test, the amount of the amount of Delta aggregate was reduced to 150 g and 3 g Portland cement was used instead of the lime. 70 g of the CQS asphalt emulsion was applied to the felt. The first aggregate was kept at the same amount as in the previous test (250 g). No bleeding of the asphalt emulsion was observed when the finely-graded Delta aggregate was spread. The sample was cured for 1 hour at 35° C. in the forced air oven as in Example 1.

### Example 3

### Adherence to Compacted Carolina Red Clay Soil

Well-moistened Carolina red clay was compacted on a felt to form a 2 cm thick clay base layer. 80 g of the 65% CQS asphalt emulsion was then spread evenly on the still moist clay base with a spatula. 250 g of the unwashed coarse aggregate and 150 g of the finely graded Delta aggregate from Example 1 were mixed with 3 g Portland cement and applied as in Example 2. The combined aggregate layer was then compacted by rolling a 1 gallon paint can, and the felt was placed in an oven as discussed in Example 1 for 1 hour. The aggregate layer was well adhered to the compacted clay base layer. Penetration of the asphalt emulsion into the clay base was negligible.

### Example 4

### Penetration of Dilute CQS Emulsion into Compacted Carolina Red Clay Soil

The 45% CQS asphalt emulsion was applied to a clay base as described in Example 3. The asphalt emulsion diluted to 45% penetrated the loosely compacted Carolina red clay soil surface, but the original 65% asphalt emulsion did not, when the asphalt emulsions were placed drop by drop from a pipette onto the red clay surface.

The moist Carolina clay was densely compacted by continuously pounding by 2″×4″ lumber. 10 g of the asphalt emulsion diluted to 45% was placed on this still moist and densely compacted clay soil. Almost no penetration of the 45% asphalt emulsion was observed.

### Example 5

### Soil Modification of Compacted Carolina Red Clay Soil

To slightly open the clay soil, 10%, 25% and 35% sand (ASTM 20-30 sand conforming to ASTM designation C778 by U.S. Silica Company) were mixed into the moist clay. These three soil samples were compacted to make dirt plugs of 10 cm in diameter and 1.25 cm in height—plug 1, plug 2 and plug 3, respectively. The CQS emulsions diluted to 30% and 45% residue were placed on plug 1. No significant penetration was observed with both emulsion samples. When 10 g of the 30% residue emulsion was placed on plug 2 (25% sand), the entire emulsion quickly penetrated into the plug. Penetration was much slower with 45% residue emulsion, and more than half of the emulsion puddled on the surface. Results were very similar with plug 3 as they were for plug 2 with the same emulsions.

### Example 6

### Blend of CQS and CRS-2 Asphalt Emulsions

The 65% CQS emulsion and the CRS-2 emulsion were blended together at the rate of 90:10 and 80:20 (Blend emulsions 1 and 2, respectively). Both blend emulsions were stable and no significant viscosity build-up was observed when they were kept at room temperature.

Blend emulsions 1 and 2 were diluted to 30%, 40% and 45% asphalt content (residue) with water. Separately, the clay plug 2 was dried overnight at room temperature after compaction. When the original blend emulsion 1 and the blend emulsion 1 diluted to 45% residue were placed on the dried clay plug 2, both blended emulsions puddled with no spreading. Some spreading on the plug surface was observed when the blend emulsion 1 was diluted to 40% and penetration into plug 2 was negligible. The blend emulsion 1 further diluted to 30% immediately penetrated into the clay plug 2 and formed a barrier after 5 drops of the emulsion was placed from a pipette at the same spot. The blend emulsion 2 diluted to 30% emulsion residue was placed on the clay plug 2 and, like the blend emulsion 1 diluted to the same residue, penetrated immediately into the clay plug 2 but formed a barrier sooner than the blend emulsion 1 diluted to the same residue.

### Example 7

### Adherence of Coarse Aggregate to Clay Plug 1

10 g of the CRS emulsion (stored at 60° C.) was applied on the clay plug 1 (prepared with 10% sand and 90% Carolina red clay) and spread with a spatula. The unwashed coarse aggregate was applied to cover the entire asphalt emulsion and compacted by rolling a paint can to apply a uniform pressure to the surface. The sample was cured for 2 hours in the forced airflow oven at 35° C. The emulsion was well attached to the clay plug and held aggregate with sufficient strength to be opened for light traffic. No significant penetration of the asphalt emulsion into the clay plug was observed.

### Example 8

### Adherence of Delta Aggregate to Clay Plug 2 and 3

15 g of the diluted blend emulsion 1 of 30% residue from Example 6 was spread on the surface of clay plug 2 dried overnight. The emulsion was allowed to penetrate and slightly dry for 10 minutes, then 10 g of the original CQS-2 (65% residue) was spread. 60 g of the Delta aggregate was spread on the asphalt emulsion and compacted with a spatula. The sample was cured at room temperature. The aggregate became very wet and bleeding of the asphalt emulsion was observed.

The same test was conducted but using the 60 g of Delta aggregate mixed with 2 g Portland cement mix. No bleeding of the asphalt emulsion through the Delta aggregate was observed and the aggregate surface had a dry appearance.

The same tests were repeated using plug 3 (35% sand) and the original and diluted CQS-2 emulsions. The same results were obtained: severe bleeding of the asphalt emulsion without the cement addition in the aggregate, but little or no bleeding when the cement was added.

Many modifications and other embodiments of the invention set forth herein will come to mind to one skilled in the art to which this invention pertain having the benefit of the teachings presented in the foregoing description and the associated drawing. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of paving an unpaved surface comprising:
applying an asphalt emulsion to an unpaved surface to form an asphalt emulsion layer on the unpaved surface, the asphalt emulsion comprising a blend of asphalt, an emulsifier, a polymer, and water;
depositing a first aggregate onto the asphalt emulsion layer, the first aggregate having an average size that is between ¼ to ¾ inches, and wherein the amount of first aggregate deposited is selected to define a layer of aggregate having void spaces that comprise up to about 70% of the aggregate layer;
depositing a second aggregate having an average size that is smaller than the first aggregate so that the second aggregate is capable of filling in the void spaces between the first aggregate, and wherein the first and second aggregate form an outer layer that is a combination of the first and second aggregate and the asphalt emulsion; and
allowing the asphalt emulsion to set to produce a paved roadway.

2. The method according to claim 1, wherein the asphalt emulsion at least partially penetrates into the unpaved surface and is formulated to have a viscosity and set rate so that the asphalt emulsion is capable of penetrating the unpaved surface to a depth of at least 0.5 inches.

3. The method according to claim 1, wherein the void spaces comprise between about 35 to 50% of the aggregate layer.

4. The method according to claim 1, wherein the first and second aggregates are deposited simultaneously.

5. The method according to claim 1, wherein the first aggregate is deposited before the second aggregate.

6. The method according to claim 1, wherein the first aggregate is a coarse aggregate and the second aggregate is a fine aggregate.

7. The method according to claim 1, further comprising the step of depositing at least 5 percent by weight aggregate having an average size that is less than about 0.003 inches.

8. The method according to claim 1, wherein the first and second aggregate collectively comprises a mixture of aggregate particles having the following distribution:
about 0.1 to 5% of the aggregate by weight having a size that is less than about 0.1 inches;
about 20 to 65% of the aggregate by weight having a size that is between 0.1 and 0.25 inches; and
about 30 to 75% of the aggregate by weight having a size that is about 0.25 inches or greater.

9. The method according to claim 1, wherein the polymer is selected from the group consisting of styrene-butadiene rubber latexes, natural rubber latexes, polychloroprene latexes, poly(styrene-butadiene-styrene block) copolymers, electrically neutral or cationic acrylic latexes, ethylene-vinyl acetate copolymers, and combinations thereof.

10. The method according to claim 1, wherein the second aggregate has an average particle size of from about 0.003 to about 0.25 inches.

11. The method according to claim 1, wherein the asphalt emulsion is a cationic asphalt emulsion selected from the group consisting of medium-setting emulsion, quick-setting emulsion, slow-setting emulsion, and combinations thereof.

12. The method according to claim 1, wherein the asphalt emulsion comprises a cationic quick setting emulsion having a Brookfield viscosity between 5 and 50 mPa·s.

13. The method according to claim 1, wherein the asphalt content in the asphalt emulsion is between 50 and 80 weight percent, based on the weight of the asphalt emulsion.

14. The method according to claim 13, wherein the polymer content is between 1 and 6 weight percent and the emulsifier content is between 0.15 and 3.8 weight percent based on the weight of the asphalt emulsion.

15. The method according to claim 1, wherein the asphalt content in the asphalt emulsion is between 25 and 50 weight percent, based on the weight of the asphalt emulsion.

16. The method according to claim 15, wherein polymer content is between about 0.5 and about 4 percent weight percent and the emulsifier content is between about 0.08 and about 2.5 percent weight percent, based on the weight of the asphalt emulsion.

17. The method according to claim 1, wherein the weight ratio of the asphalt to the polymer is from 12.5:1 to 50:1.

18. The method according to claim 1, wherein the weight ratio of the asphalt to the emulsifier is from 20:1 to 333:1.

19. The method according to claim 1, further comprising the step of applying a second asphalt emulsion onto the aggregate.

20. The method according to claim 1, further comprising the step of mixing the unpaved surface with sand prior to the step of applying the asphalt emulsion.

21. A method of paving an unpaved surface comprising:
applying an asphalt emulsion to an unpaved surface to form an asphalt emulsion layer on the unpaved surface, the asphalt emulsion comprising a blend of asphalt, an emulsifier, a polymer, and water;
depositing an aggregate onto the asphalt emulsion layer, the aggregate having an average size that is between 0.003 and 0.25 inches; and
allowing the asphalt emulsion to set to produce a paved roadway.

22. The method according to claim 21, wherein the emulsion comprises an emulsion having a Brookfield viscosity between 5 and 50 mPa·s.

23. The method according to claim 21, wherein the asphalt content in the asphalt emulsion is between 50 and 80 weight percent, based on the weight of the asphalt emulsion.

24. The method according to claim 23, wherein the polymer content is between 1 and 6 weight percent and the emulsifier content is between 0.15 and 3.8 weight percent based on the weight of the asphalt emulsion.

25. The method according to claim 21, wherein the asphalt content in the asphalt emulsion is between 25 and 50 weight percent, based on the weight of the asphalt emulsion.

26. The method according to claim 25, wherein polymer content is between about 0.5 and about 4 percent weight percent and the emulsifier content is between about 0.08 and about 2.5 percent weight percent, based on the weight of the asphalt emulsion.

27. The method according to claim 21, wherein the weight ratio of the asphalt to the polymer is from 12.5:1 to 50:1.

28. The method according to claim 21, wherein the weight ratio of the asphalt to the emulsifier is from 20:1 to 333:1.

29. A paved roadway comprising:
a base layer comprising an existing unpaved surface having a composition; and
an outer use layer disposed above the base layer, the outer use layer comprising a blend of a first aggregate having an average size between 0.25 and 1 inch, and a second aggregate having an average size between 0.003 and 0.25 inches, and wherein the first and second aggregate are bound to together within an asphalt-polymer matrix to form a paved roadway.

30. The paved roadway according to claim 29, wherein the asphalt-polymer matrix penetrates into the base layer so that the outer layer and base layer are bound together.

31. The paved roadway according to claim 30, wherein the base layer comprises an upper portion that is bound together with the asphalt-polymer matrix and a lower portion that is substantially free of the asphalt-polymer matrix.

32. The paved roadway according to claim 31, wherein the upper portion has a thickness that is between 0.5 to 8 inches.

33. The paved roadway according to claim 29, wherein the aggregate includes a first aggregate comprising a mixture of particles having an average size that is between 0.25 and 0.75 inches and a second aggregate comprising a mixture of particles having an average diameter that is less than about 0.1 inches.

34. The paved roadway according to claim 29, wherein the aggregate comprises a mixture of different sized particles that have diameters ranging between about 0.003 inches to about 0.5 inches.

35. The paved roadway according to claim 29, wherein the aggregate comprises a mixture of particles having the following size distribution:
about 0.1 to 5% of the aggregate by weight have a diameter that is less than 0.003 inches;
about 20 to 30% of the aggregate by weight having a diameter that is less than 0.1 inches; and
about 65 to 75% of the aggregate by weight having a diameter that is greater than about 0.1 inches.

36. The paved roadway according to claim 29, wherein the polymer is selected from the group consisting of styrene-butadiene rubber latexes, natural rubber latexes, polychloroprene latexes, poly(styrene-butadiene-styrene block) copolymers, electrically neutral or cationic acrylic latexes, ethylene-vinyl acetate copolymers, and combinations thereof.

37. The paved roadway according to claim 29, wherein the weight ratio of the asphalt to the polymer in the outer use layer is from 12.5:1 to 50:1.

38. An asphalt emulsion comprising:
an asphalt component;
a cationic emulsifier in a weight ratio of the asphalt to the emulsifier from 20:1 to 333:1;
a polymer in a weight ratio of the asphalt to the polymer from 12.5:1 to 50:1; and
the balance water and optionally acids,
wherein the asphalt emulsion has a Brookfield viscosity between 5 and 250 mPa·s.

39. The asphalt emulsion according to claim 38, wherein the asphalt emulsion has a Brookfield viscosity that is between 5 and 50 mPa·s.

40. The asphalt emulsion according to claim 38, wherein the asphalt emulsion has a Brookfield viscosity that is between 5 and 35 mPa·s.

41. The asphalt emulsion according to claim 38, wherein the asphalt emulsion has a Brookfield viscosity that is between 5 and 20 mPa·s.

42. The asphalt emulsion according to claim 38, wherein the asphalt content is between 50 and 80 weight percent, the polymer content is between 1 and 6 weight percent, and the emulsifier content is between 0.15 and 3.8 weight percent.

43. The asphalt emulsion according to claim 38, wherein the asphalt content is between 25 and 50 weight percent, the polymer content is between about 0.5 and about 4 percent weight percent, and the emulsifier content is between about 0.08 and about 2.5 percent weight percent.
